(19) United States
(12) Patent Application Publication
(10) Pub. No.: US 2013/0151379 A1
(43) Pub. Date: Jun. 13, 2013

(54) METHOD AND SYSTEM FOR MANUFACTURING AND DELIVERING A FRAMED PICTURE

(71) Applicant: Andrew EDWARDS, Kuala Lumpur (MY)

(72) Inventor: Andrew EDWARDS, Kuala Lumpur (MY)

(21) Appl. No.: 13/550,891

(22) Filed: Jul. 17, 2012

(30) Foreign Application Priority Data
Dec. 8, 2011 (MY) PI 2011005948

(51) Int. Cl. G06Q 30/06

(52) U.S. Cl. 705/26.81

(57) ABSTRACT

A method of manufacturing and delivery of a framed picture includes acquiring a digital picture with a user device; selecting a frame type for framing the acquired digital picture using the user device; sending the digital picture and frame selection from the user device to a manufacturer system; acquiring delivery details for delivery of the framed picture; manufacturing the framed picture from the selected frame type and the sent digital picture; applying the delivery details to the manufactured framed picture for identifying the delivery address; and delivering the manufactured framed picture to the delivery address according to the delivery details.

### FIELD OF THE INVENTION

The present invention relates to manufacture and delivery a framed picture.

### BACKGROUND

Presently picture framing is conducted in a store. A person wanting a picture framed goes to the store, leaves the picture and returns when it is ready or waits while it is framed. The frame selection is manual and the handling is done in person or delivery via a courier or postal service is manually arranged.

The present invention seeks to improve this process.

### SUMMARY OF THE PRESENT INVENTION

According to the present invention there is provided a method of manufacturing and delivery of a framed picture comprising:

acquiring a digital picture with a user device;

selecting a frame type for framing the acquired digital picture using the user device;

sending the digital picture and frame selection from the user device to a manufacturer system;

acquiring delivery details for delivery of the framed picture;

manufacturing the framed picture from the selected frame type and the sent digital picture;

applying the delivery details to the manufactured framed picture for identifying the delivery address;

delivering the manufactured framed picture to the delivery address according to the delivery details.

In an embodiment the method further comprises registering a user including recording delivery details against a user's identity, and sending the user identity to the manufacturer system, wherein acquiring delivery details for delivery of the framed picture comprises retrieving the recorded delivery details using the sent user identity.

In an embodiment acquiring the digital picture comprises one or more of selecting a picture from a plurality of choices, capturing a picture with a camera or scanner, creating a picture with a computer program, or editing an image.

In an embodiment selecting a picture from a plurality of choices comprises displaying the choices.

In an embodiment selecting a frame type comprises displaying a plurality of choices of frame type. In an embodiment the frame type comprises one or more of the actual frame surrounding the picture, a matt board bordering the picture, or a hanging style.

In an embodiment selecting a frame type comprises displaying an image of the acquired picture with an image of the selected frame type as it would appear when framed.

According to the present invention there is provided a system for manufacturing and delivery of a framed picture comprising:

an order processor configured to receive delivery details;

a device for acquiring a digital picture;

a user interface for selecting a frame type for framing the acquired digital picture;

a transmitter for sending the digital picture and frame type selection to the order processor;

a picture printer and framer for manufacturing the framed picture from the selected frame type and the sent digital picture when the order processor receives the digital picture and frame type selection;

a delivery details applicator for applying the delivery details received by the order processor to the manufactured framed picture for identifying the delivery address such that the manufactured framed picture is able to be delivered to the delivery address according to the delivery details.

In an embodiment the order processor is configured to register a user, wherein registering the user comprises recording the delivery details against a user's identity.

In an embodiment the device comprises the user interface.

In an embodiment the device is configured to send the user identity to the order processor using the transmitter.

In an embodiment the order processor is configured to receive the delivery details and store them for later retrieval and use by the delivery details applicator.

According to the present invention there is provided a system for manufacturing and delivery of a framed picture comprising:

means for acquiring an digital picture;

means for selecting a frame type for framing the acquired digital picture;

means for sending the digital picture to a manufacturer system;

means for manufacturing the framed picture from the selected frame type and the sent digital picture;

means for applying the retrieved delivery details to the manufactured framed picture for identifying the delivery address;

means for delivering the manufactured framed picture to the delivery address according to the delivery details.

In an embodiment the system further comprises a means for registering a user including recording delivery details against a user's identity and means for retrieving the recorded delivery details using the sent user identity.

According to the present invention there is provided a user device for ordering manufacture and delivery of a framed picture comprising:

a user interface for entering delivery details;

a user interface for acquiring a digital picture;

a user interface for selecting a frame type for framing the acquired digital picture;

a transmitter for sending the delivery details, digital picture and frame type selection to an order processor, such that the order processor can control printing of the sent digital printer and framing of the printed printer according to the sent selected frame type and delivery details can be applied to the framed picture for delivery to a delivery address according to the delivery details.

According to the present invention there is provided a method of ordering manufacture and delivery of a framed picture comprising:

entering delivery details into a user device;

acquiring a digital picture using the user device;

selecting a frame type for framing the acquired digital picture using the user device;

sending the delivery details, digital picture and frame type selection from the user device to an order processor, such that the order processor can control printing of the sent digital printer and framing of the printed printer according to the sent selected frame type and delivery details can be applied to the framed picture for delivery to a delivery address according to the delivery details.

According to the present invention there is provided a system for receiving an order, manufacturing and delivery of a framed picture comprising:

a receiver for receiving from a user device delivery details, selection of a stored digital picture or a download of a digital picture and a frame type selection;

a picture printer and framer for manufacturing the framed picture from the selected frame type and the sent digital picture;

a delivery details applicator for applying the delivery details received by the order processor to the manufactured framed picture for identifying the delivery address such that the manufactured framed picture is able to be delivered to the delivery address according to the delivery details.

According to the present invention there is provided a method of manufacturing and delivery of a framed picture comprising:

receiving from a user device delivery details, selection of a stored digital picture or a download of a digital picture and a frame type selection;

manufacturing the framed picture from the selected frame type and the selected or sent digital picture;

applying the delivery details to the manufactured framed picture for identifying the delivery address;

delivering the manufactured framed picture to the delivery address according to the delivery details.

According to the present invention there is provided a set of instructions for controlling a system to operate as one or more of the systems defined above.

According to the present invention there is provided a set of instructions for controlling a system to perform one or more of the methods defined above.

In this specification the terms “comprising” or “comprises” are used inclusively and not exclusively or exhaustively.

### DESCRIPTION OF DRAWINGS

In order to provide a better understanding of the present invention preferred embodiments will now be described, by way of example only, with reference to the accompanying drawings, in which:

FIG. 1 is a schematic block diagram of a system for manufacturing and delivery of a framed picture according to an embodiment of the present invention;

FIG. 2 is a schematic block diagram of a user device of the system of FIG. 1;

FIG. 3 is a schematic block diagram of an order processor of the system of FIG. 1;

FIG. 4 is a schematic block diagram of a production controller of the system of FIG. 1;

FIG. 5 is a schematic block diagram of a production component controlled by the controller of FIG. 4;

FIG. 6 is a schematic block diagram of a computer network that interfaces with the order processor of the system of FIG. 1;

FIG. 7 is a schematic flow chart showing steps of a method of manufacturing and delivery of a framed picture according to an embodiment of the present invention.

FIG. 8 shows a schematic representation of modules of the order processor of FIG. 3;

FIG. 9 shows a schematic representation of modules of the user device of FIG. 2;

FIG. 10 shows a screen shot of a login page displayed on a user interface of the user device of FIG. 2;

FIG. 11 shows a screen shot of an account summary page displayed on a user interface of the user device of FIG. 2;

FIG. 12 shows a screen shot of an order history page displayed on a user interface of the user device of FIG. 2;

FIG. 13 shows a screen shot of a saved projects page displayed on a user interface of the user device of FIG. 2;

FIG. 14 shows a screen shot of a main options page displayed on a user interface of the user device of FIG. 2;

FIG. 15 shows a screen shot of a photo design studio page displayed on a user interface of the user device of FIG. 2;

FIG. 16 shows a screen shot of a picture library page displayed on a user interface of the user device of FIG. 2;

FIG. 17 shows a screen shot of a camera interface page displayed on a user interface of the user device of FIG. 2;

FIG. 18 shows a screen shot of pictures available for purchase page displayed on a user interface of the user device of FIG. 2;

FIG. 19 shows a screen shot of a picture editor page displayed on a user interface of the user device of FIG. 2;

FIG. 20 shows a screen shot of a frame selection page displayed on a user interface of the user device of FIG. 2;

FIG. 21 shows a screen shot of a shopping cart page displayed on a user interface of the user device of FIG. 2;

FIG. 22 shows a screen shot of an order summary page displayed on a user interface of the user device of FIG. 2;

FIG. 23 shows a screen shot of a payment page displayed on a user interface of the user device of FIG. 2; and

FIG. 24 shows a screen shot of an order sent confirmation page displayed on a user interface of the user device of FIG. 2.

### DESCRIPTION OF EMBODIMENTS OF THE INVENTION

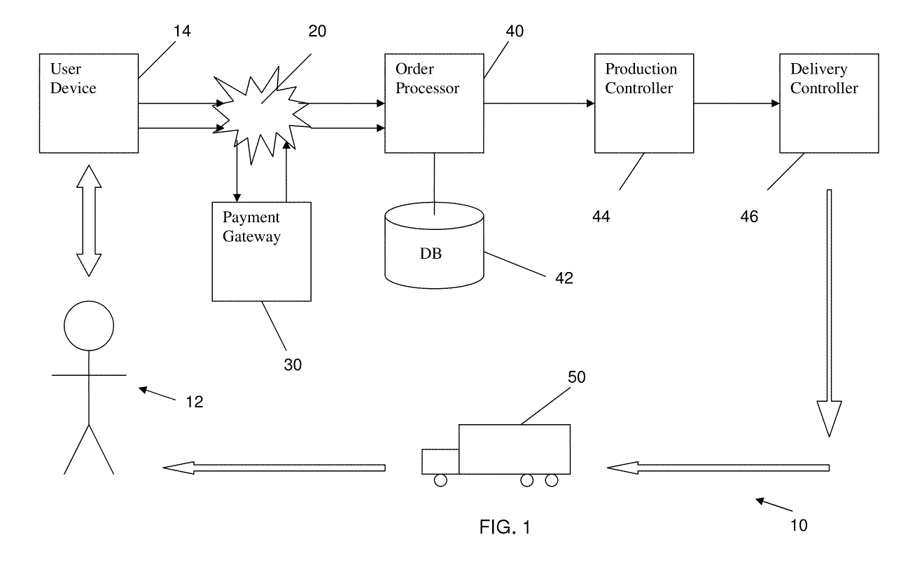

Referring to FIG. 1 is a schematic block diagram of a system 10 for manufacturing and delivery of a framed picture according to an embodiment of the present invention. The system 10 comprises a user device 14 for interacting with a user 12 of the system 10. The user device 14 is configured to communicate over a telecommunications medium 20, such as a telephone and/or data network, including the Internet, with an order processor 40. The user device 14 may also be configured to communicate over the medium 20 with a payment gateway 30. In an embodiment the order processor 40 communicates with the payment gateway 30 in conjunction with the user device. In another embodiment only the order processor 40 communicates with the payment gateway 30. Payment information is relayed to the order processor 40 to the payment gateway 30. The payment gateway 30 may be provided by a third party, such as a Paypal™ payment gateway, Amazon™ payment gateway, Google™ payment gateway or other suitable payment gateway. In an embodiment the order processor 40 comprises a storage medium, such as a hard disk drive, for storing information. Typically the information is formatted into a database 42. In an embodiment the order processor 40 is in communication with or comprises a production controller 44. The production controller 44 is configured to control production of the framed picture as will be described in more detail below. Delivery details are applied to the produced framed picture by a delivery details applicator 46. The produced framed picture is delivered to the user 12 by transport 50, such as a courier or postal service according to the delivery details.

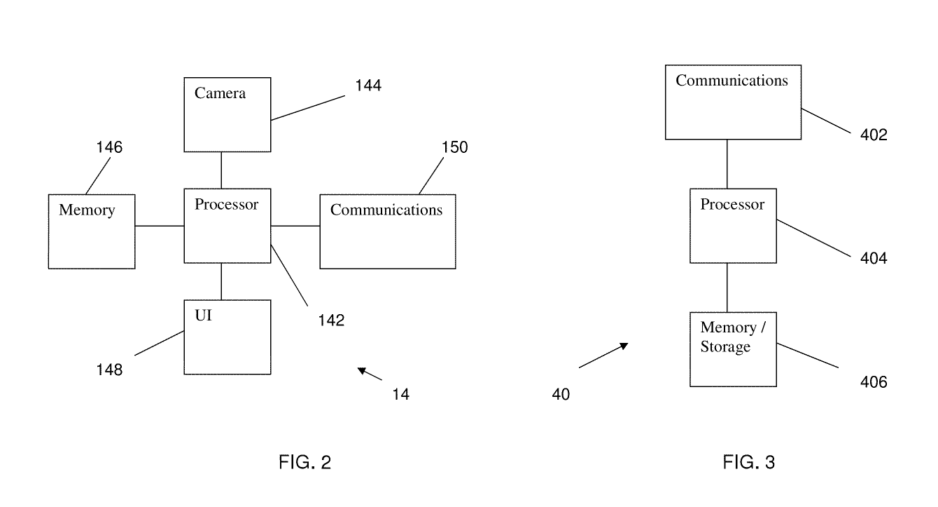

Referring to FIG. 2 there is shown a schematic block diagram of the user device 14, which comprises a processor 142 in control of and in communication with a camera 144 or scanner for capturing an image/picture, a memory 146 for storing the picture, a user interface 148 for interacting with the user 12 and a communications module 150 for communicating with the telecommunications medium 20. The user interface 148 will typically comprise a display, such as an LCD, LED or other suitable screen, and a user input device, such as a mouse, keyboard or touch screen input. The user device 14 may be a personal computer, portable computer, “netbook”, PDA, tablet device or smart phone, for example. The user device 14 may be move than one device connected or used in order to achieve the functionality of the user device 14.

In one embodiment the processor 142 is controlled by a computer program loaded into the memory 146. The computer program may be a smart phone application. The computer program comprises instructions that control the processor 142 such that it is configured to have the modules and to perform as described further below.

FIG. 3 shows a schematic block diagram of the order processor 40, which comprises a processor 404 in control of and in communication with a memory 406 for storing the instructions for the processor and a communications module 402 for communicating with the telecommunications medium 20. Typically the order processor 40 will be a computer server.

The processor 404 is controlled by a computer program loaded into the memory 406. The computer program may be a custom built application. The computer program comprises instructions that control the processor 404 such that it is configured to perform as described further below.

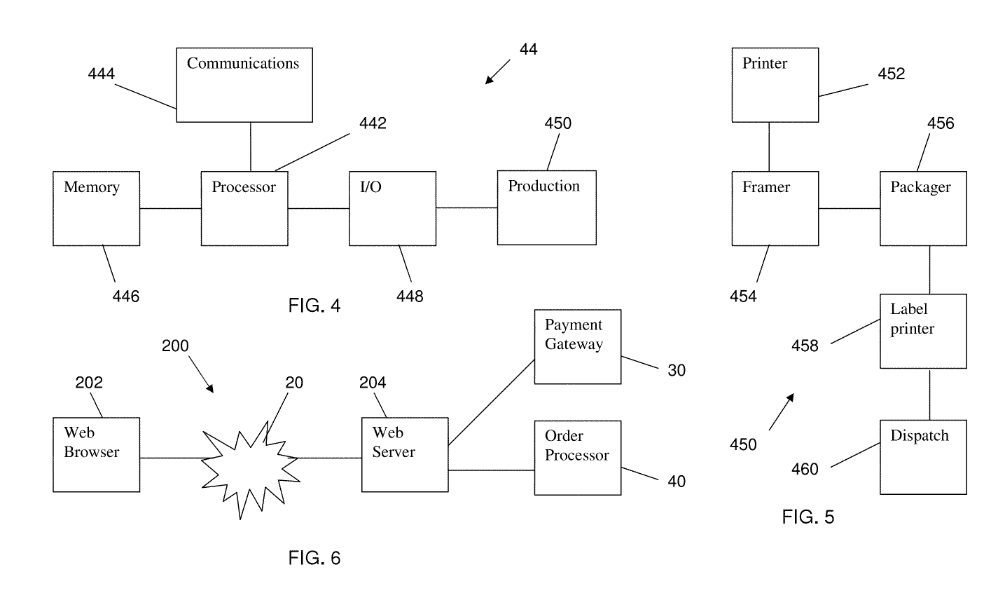

FIG. 4 shows a schematic block diagram of the production controller 44, which comprises a processor 442 in control of and in communication with a memory 446 for storing the instructions for the processor and a communications module 444 for communicating with the order processor 40. The communications module 444 may interact with the communications module 402 via a local network or over a wide area network. In an alternative the order processor 40 is configured to operate as the production controller 44. In this embodiment the communications module 444 may pass messages or signals to an order processing module of the order processor 40. The order processing module is a logical component of the order processor 40 that provides the functionality ascribed to the order processor 40.

The production controller 44 further comprises an Input/Output module 448 that interfaces to a production component 450. In one embodiment the production component 450 is in the form of a printer and the I/O module 448 comprises a printer driver and connectivity infrastructure. In another embodiment the production component 450 is in the form of a plurality of printers and the I/O module 448 comprises the required printer drivers and connectivity infrastructure. In a further embodiment the production component 450 comprises further machinery and the I/O module 448 further comprises other connectivity infrastructure.

The processor 442 is controlled by a computer program loaded into the memory 446. The computer program may be a custom built application. The computer program comprises instructions that control the processor 442 such that it is configured to perform as described further below.

FIG. 5 shows a schematic block diagram of an embodiment of production component 450. In this embodiment the production component 450 is an automated fabrication system comprising one or more printers 452 for printing pictures on one or more different types or sizes of paper, or other substrates, a framer 454 for mounting the printed picture in a selected frame, a packager 456 for packaging the framed picture for delivery, a label printer for printing a label containing delivery information for affixing to the packaged framed picture and a dispatcher 460 for delivering the labelled package to the transport 50 for delivery to the user 12. The parts of the production component 450 may be automated or semi-automated in a production line.

FIG. 6 shows a schematic block diagram of a computer network 200 that interfaces with the order processor 40. The computer network 200 comprises the medium 20, a web browser 202, a web server 204, the order processor 40 and in one embodiment a payment gateway 30. In one embodiment the server operating as the order processor 40 also operates as the web server 204, although it may be desirable for them to operate as different machines that are housed together or housed remotely. The web browser 202 may operate on the user device 14 or another device. The web browser 202 is configured to receive input, which in part, along with input from the order processor 40 and payment gateway 30 determine what information will be packaged into a web page by the web server 204 for transmission to the web browser 202 for display.

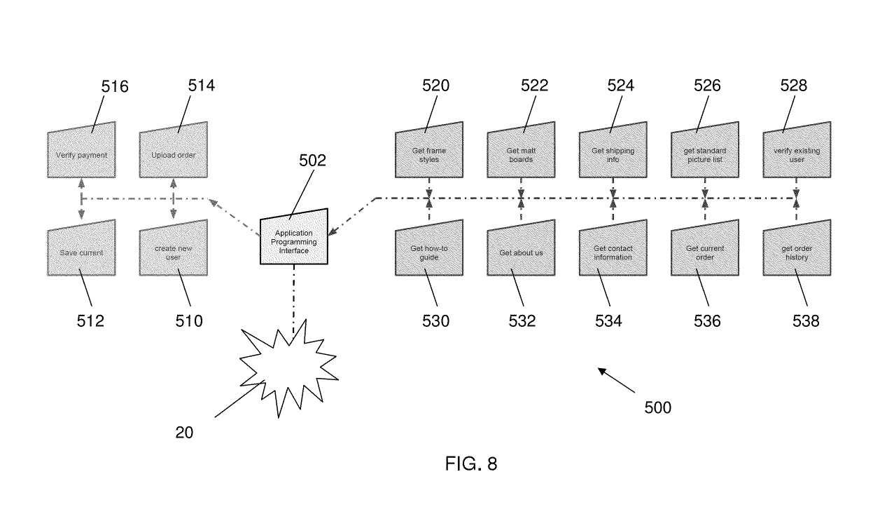

FIG. 8 shows a schematic representation 500 of modules of the order processor 40. The modules are functional components of the order processor 40 and may be achieved by suitable electronic circuits or by controlling of the processor 404 to logically achieve these modules. The representation 500 comprises an Application Programming Interface (API) 502 that interfaces the user device 14 to the other modules over the medium 20. The other modules comprise:
a create new user module 510 that creates and registers a user identity with order processor 40;
a save current module 512 that stores in the database 42 the current position in the ordering process for later retrieval and continuation;
an upload order module 514 that receives a picture for framing and a selection of a type of frame;
a verify payment module 516 that interacts with the payment gateway 30 to verify that the user has paid for the placed order;
a get frame styles module 520 that retrieves from the database 42 a list of and specifications of (which may include images of) each of the styles of frame that are available for selection by the user 12;
a get matt boards module 522 that retrieves from the database 42 a list of and specifications of (which may include images of) each of the styles of matt board that are available for selection by the user 12;
a get shipping info module 524 that retrieves from the database 42 the delivery details recorded for the registered user 12 or formats a query to the user 12 requesting delivery information and receives the reply from the user to the query;
a get standard picture list module 526 that retrieves from the database 42 a list of and specifications of (which may include images of) each of the available standard pictures that can be selected by the user 12 for framing;
a verify existing user module 528 that receives a user login request and retrieves login verification information from the database 42, such as a username and password, and verifies the identity of the user from the received and retrieved information;
a get how-to guide module 530 that retrieves from the database 42 instructional information for the user 12 on how to use the system 10 and sends it to the user device 14 for display to the user 12;
a get about us module 532 that retrieves from the database 42 information about the provider of the system 10 and sends it to the user device 14 for display to the user 12;
a get contact information module 534 that retrieves from the database 42 contact information for the provider of the system 10 and sends it to the user device 14 for display to the user 12;
a get current order module 536 that retrieves from the database 42 information on any current orders placed by the user with the system 10 and sends it to the user device 14 for display to the user 12;
a get order history module 538 that retrieves from the database 42 information of on any prior orders placed by the user with the system 10 and sends it to the user device 14 for display to the user 12.

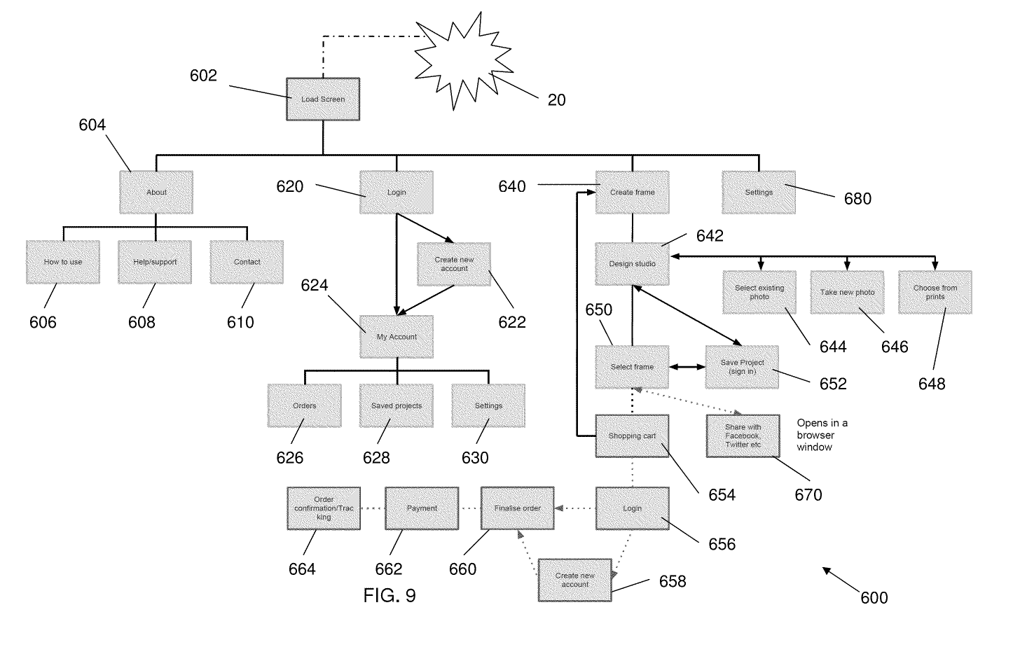

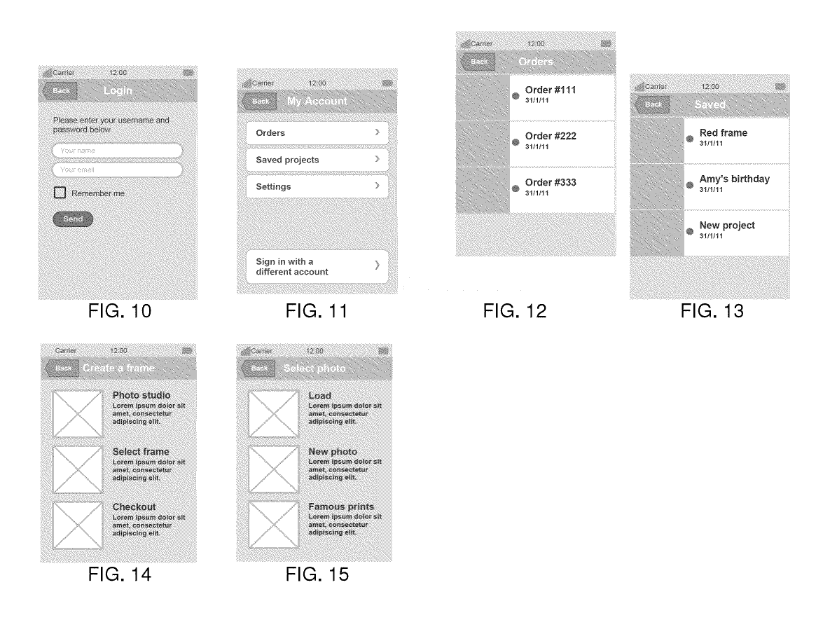

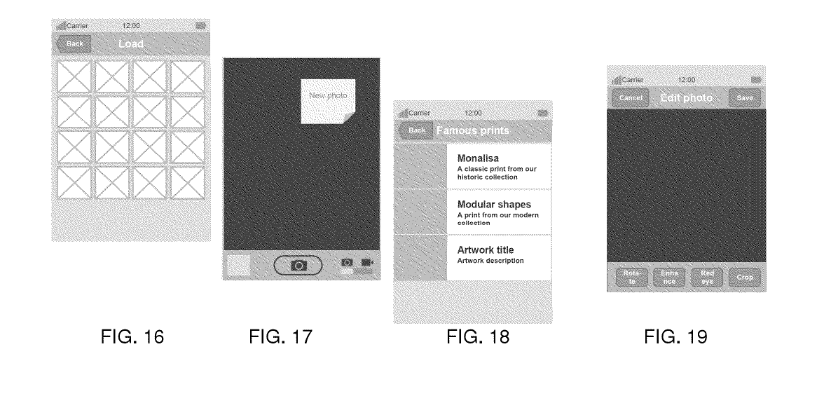

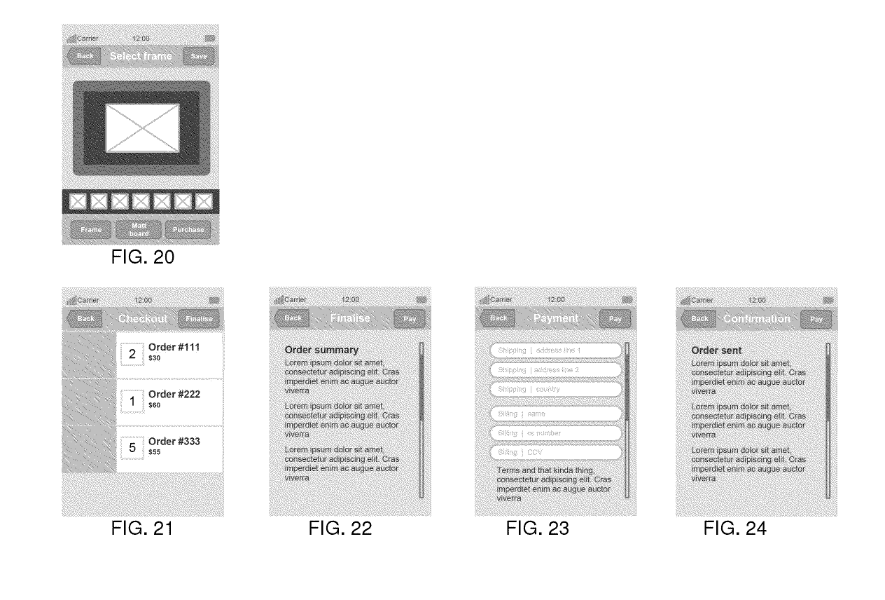

FIG. 9 shows a schematic representation 600 of modules of the user device 14. The modules are functional components of the user device 14 and may be achieved by suitable electronic circuits or by controlling of the processor 142 to logically achieve these modules. These modules of user device 14 interface with the API 502 over the medium 20. The representation 600 comprises the following modules:
a load screen module 602 that is displayed when the application is started on the user device 14 while the application initializes and establishes a connection over the medium 20 with the order processor 40. A main menu is shown to the user to select from. From this page the user can select one of an about page, a login page, a create frame page or a settings page. In an embodiment only the first two options are available until the user is logged in;
an about module 604 that is activated when the about page is selected and calls the module 532 to retrieve and display information about the provider of the system 10 to the user in the about screen. From this page the user can select one of a how to use page, a help/support page, a contact page or return to the main menu page;
a how to use module 606 that is activated when the how to use page is selected and calls the module 530 to retrieve and display information about how to use the system 10 to the user in the how to use page. From this page the user can go back to the about page;
a help/support module 608 that is activated when the help/support screen is selected and calls the module 530 to retrieve and display more detailed information about how to use a particular aspect of the system 10 to the user in the help/support page. From this page the user can go back to the about page;
a contact module 610 that is activated when the contact page is selected and calls the module 534 to retrieve and displays contact information about the provider of the system 10 to the user in the contact screen. From this page the user can go back to the about page;
a login module 620 that is activated when the login screen is selected and retrieves any user login information saved in memory 146. An example login page is shown in FIG. 10. If there is no saved information module 620 activates a create new account module 622, otherwise the module 620 calls the module 528 and sends the user login information to module 528 to verify the identity of the user. Once verified the module 620 activates a my account module 624;
the create new account module 622 calls module 510 to create a new user identity and registered the user 12. Once user account is created the module 622 activates the my account module 624;
the my account module 624 calls module 510 and displays information about the user's account to the user in a my account page, such as shown in FIG. 11. From this page the user can select one of an orders page, a saved projects page, a settings page or return the main menu page;
an orders module 626 that is activated when the order page is selected and calls the modules 536 and 538 to retrieve and display information about current orders and historic orders to the user in the orders page, such as shown in FIG. 12. From this page the user can go back to the my account page;
a saved projects module 626 that is activated when the saved projects page is selected and calls the module 512 to retrieve a partly completed project. An example of the saved projects page is shown in FIG. 13. If a saved project is selected the user 12 can continue from wherever they where up to at the time of saving the project. From this page the user can continue where they were up to or go back to the my account page;
a settings module 626 that allows account settings to the stored. From this page the user can go back to the my account page;
a create frame module 640 that allows the user to create a frame project. This module may automatically progress through the steps or may provide menu choices of photo studio page, select frame page or checkout page, such as shown in FIG. 14. If automatic, module 640 then activates a design studio module 642;
the design studio module 646 allows the user to select the picture to be framed. The user can select from an existing photo, take a new photo, choose from a standard picture, edit a picture or save a selected picture without yet selecting a frame, such as is shown in FIG. 15. The edit a picture page, such as is shown in FIG. 18 provide the standard functionality of a picture editor, such as rotating the image, cropping, red-eye removal, image enhancements such as varying contrast, brightness, conversion to a sepia or black and white image etc;
a select existing photo module 644 that is activated when the select existing photo page is selected, displays a set of thumb nails of photos stored in the memory 146 of the user device 14 and allows the user to select one of the photos, such as is shown in FIG. 16. From this page the user can go back to the design studio screen or progress to a select frame page;
a take new photo module 646 that is activated when the take new photo page is selected, activates the camera 144 to take a new photo, which is stored in the memory 146 of the user device 14 and becomes the selected picture, such as is shown in FIG. 17. From this page the user can go back to the design studio screen or progress to a select frame page;
a choose from prints module 644 that is activated when the choose from standard picture page is selected, calls module 526 displays a set of thumb nails of pictures stored in the database 42 of the order processor 40 and allows the user to select one of the pictures, such as is shown in FIG. 18. From this page the user can go back to the design studio page or progress to a select frame page;
a select frame module 650 that is activated when the user progresses to the select frame screen, calls modules 520 and 522, retrieves from database 42 and displays a section of frame styles and matt boards for the user to select, such as is shown in FIG. 20. The user may be shown what the selected picture will look like with a selected frame type and matt board until a final selection is made by the user or the user decides to save the incomplete project. From this page the user can save the project, progress to a shopping cart page or share selections;
a save project module 652 that calls module 512 to save the current place and selections or if retrieving a saved project places the application in the state it was at when the project was saved, including retrieving the saved selections. From this page the user can go back to either the design studio page or the select frame page depending on where the user was up to;
a shopping cart module 654 displays the orders ready to be purchased along with the price, such as is shown in FIG. 21. The user can select an order or orders to proceed with. From this page the user will progress to a payment gateway login page or return to the create frame page;
a payment gateway login module 656 that establishes communication with the payment gateway 30 and calls a payment gateway login API to establish the identity of the user with the payment gateway 30. If the user does not have an account with the payment gateway 30 then a create new payment gateway user account page will be activated, otherwise a finalise order page will commence;
a create new payment gateway user account module 658 calls a create new payment gateway user API to create a new user identity with the payment gateway 30. Once the payment gateway user account is created the module 658 progresses to finalise order page;
a finalise order module 660 that is activated by the module 656 or 658 calls module 514, confirms the details of the order and displays the cost of the order for making payment by the user 12, such as is shown in FIG. 22;
a payment module 662 that activated when the user confirms payment, calls module 516 to received confirmation of the payment from the payment gateway 30 and displays to the user that the payment has been made, such as is shown in FIG. 23;
an order confirmation/tracking module 664 that is activated when module 516 received confirmation of payment from the payment gateway 30 provides and order confirmation and tracking information to the user 12, such as is shown in FIG. 24, so that the user can track the progress of the order. When the user is ready the application will return to the main menu;
a share module 670 that calls a browser window to open with information to allow the user to share the selections with friend via social media, such as Facebook™ or Twitter™; and
a settings module 680 that allows application settings to the stored. From this page the user can go back to the main menu page.

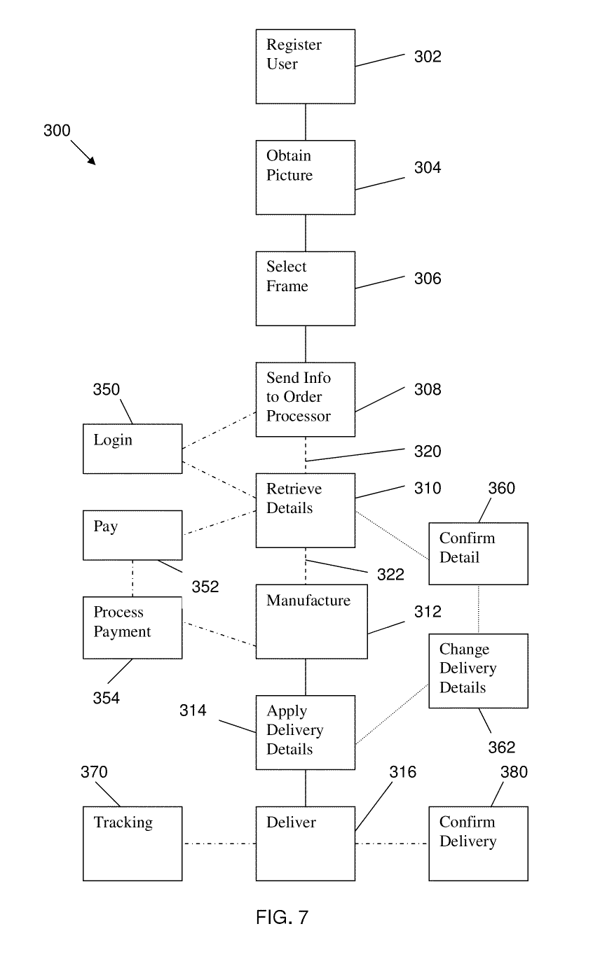

FIG. 7 is a schematic flow chart showing steps of a method 300 of manufacturing and delivery a framed picture according to an embodiment of the present invention. In this embodiment the process commences with registering the user 302. However this step may occur later in the sequence. The user may be registered with the order processor via a web site prior to use of the application in the user device 14, or the user may download and install the application to their user device 14 and they can register, for example, by using module 622. Registration of the user will usually include recording of a delivery address against the identity of the user.

The user obtains a picture 304. This may be by use of modules 642-648. The user selects a frame 306. This may be by use of module 650.

The information in the order is sent to the order processor 308, such as by use of module 654. The information will include the selected picture, the selected frame and if applicable matt board and the identity of the user. The information about the selected picture may include sending the picture to the order processor 40, or if the picture is a standard image, then the identification of the image for retrieval.

In one embodiment the delivery details are retrieved 310 from the identification of the user. Alternatively the delivery details are sent to the order processor 40 by module 654 or 660.

The order processor 40 then sends the production controller 44 the necessary information to manufacture 312 the framed photo. This will include printing the picture with printer 452, framing the printed picture with framer 454 and packaging the framed picture with packager 456. The delivery details are then applied 314 to the package. This may be done by the label printer 458 printing the delivery details on an adhesive label which is affixed to the package. The Dispatcher 460 then dispatches the labelled package to the transport 50 for delivery 316 according to the delivery details.

Typically the identity of the user is known to the order processor 40 by having a registered user login 350 by using module 620. However the user may be anonymous or a one-time user, so the login step 350 is not essential. If login occurs step 308 does not progress directly to step 310 and line 320 may be ignored.

Typically the user will pay for each order. Thus instead of progressing directly from step 310 to step 312, line 322 may be ignored and additional steps pay 352 and process payment 354 are included in the method 300. Pay step 352 uses module 662 to receive details of how the user wishes to pay. Once supplied to the payment gateway 30 the payment gateway will process the payment 354 and inform the order processor 40 that the payment has been made. Typically the user will also be informed that the payment has been successful by use of module 664.

The user may wish to change the delivery details from those recorded for the user, such as if the framed picture is to be a gift. Also when the user is anonymous or a one-time user there may not be stored delivery details. The user may be given the option of confirming the delivery details 360, and to provide new details 362 or if there are none to enter the delivery details. These will be applied to the packaged framed picture.

Dispatch of the package may be tracked 370 by recording a shipping tracking number, such as those provided by couriers or postal services and the progress can be tracked via the web browser 202. Also the progress in manufacturing the framed image may also be tracked by looking up an order number via the web browser 202, which interfaces with the order processor 40 via the web server 204 to determine where within the manufacturing process the order is up to. Further when the package is delivered the courier or postal services may inform the order processor 40 that the package is delivery 380 and thus delivery is confirmed.

Modifications may be made to the present invention with the context of that described and shown in the drawings. Such modifications are intended to form part of the invention described in this specification.

1. A method of manufacturing and delivery of a framed picture comprising:
acquiring a digital picture with a user device;
selecting a frame type for framing the acquired digital picture using the user device;
sending the digital picture and frame selection from the user device to a manufacturer system;
acquiring delivery details for delivery of the framed picture;
manufacturing the framed picture from the selected frame type and the sent digital picture;
applying the delivery details to the manufactured framed picture for identifying the delivery address;
delivering the manufactured framed picture to the delivery address according to the delivery details.

2. A method as claimed in claim 1, wherein the method further comprises registering a user including recording delivery details against a user's identity, and sending the user identity to the manufacturer system, wherein acquiring delivery details for delivery of the framed picture comprises retrieving the recorded delivery details using the sent user identity.

3. A method as claimed in class 1, wherein acquiring the digital picture comprises one or more of selecting a picture from a plurality of choices, capturing a picture with a camera or scanner, creating a picture with a computer program, or editing an image.

4. A method as claimed in claim 1, wherein selecting a picture from a plurality of choices comprises displaying the choices.

5. A method as claimed in claim 1, wherein selecting a frame type comprises displaying a plurality of choices of frame type. In an embodiment the frame type comprises one or more of the actual frame surrounding the picture, a matt board bordering the picture, or a hanging style.

6. A method as claimed in claim 1, wherein selecting a frame type comprises displaying an image of the acquired picture with an image of the selected frame type as it would appear when framed.

7. A system for manufacturing and delivery of a framed picture comprising:
an order processor configured to receive delivery details;
a device for acquiring a digital picture;
a user interface for selecting a frame type for framing the acquired digital picture;
a transmitter for sending the digital picture and frame type selection to the order processor;
a picture printer and framer for manufacturing the framed picture from the selected frame type and the sent digital picture when the order processor receives the digital picture and frame type selection;
a delivery details applicator for applying the delivery details received by the order processor to the manufactured framed picture for identifying the delivery address such that the manufactured framed picture is able to be delivered to the delivery address according to the delivery details.

8. A system as claimed in claim 7, wherein the order processor is configured to register a user, wherein registering the user comprises recording the delivery details against a user's identity.

9. A system as claimed in claim 7, wherein the device comprises the user interface.

10. A method as claimed in claim 7, wherein the device is configured to send the user identity to the order processor using the transmitter.

11. A method as claimed in claim 7, wherein the order processor is configured to receive the delivery details and store them for later retrieval and use by the delivery details applicator.

12. A system for manufacturing and delivery of a framed picture comprising:
means for acquiring an digital picture;
means for selecting a frame type for framing the acquired digital picture;
means for sending the digital picture to a manufacturer system;
means for manufacturing the framed picture from the selected frame type and the sent digital picture;
means for applying the retrieved delivery details to the manufactured framed picture for identifying the delivery address;
means for delivering the manufactured framed picture to the delivery address according to the delivery details.

13. A system as claimed in claim 12, wherein the system further comprises a means for registering a user including recording delivery details against a user's identity and means for retrieving the recorded delivery details using the sent user identity.

14. A user device for ordering manufacture and delivery of a framed picture comprising:
a user interface for entering delivery details;
a user interface for acquiring a digital picture;
a user interface for selecting a frame type for framing the acquired digital picture;
a transmitter for sending the digital picture and frame type selection to an order processor, such that the order processor can control printing of the sent digital printer and framing of the printed printer according to the sent selected frame type and delivery details can be applied to the framed picture for delivery to a delivery address according to the delivery details.

15. A method of ordering manufacture and delivery of a framed picture comprising:
entering delivery details into a user device;
acquiring a digital picture using the user device;
selecting a frame type for framing the acquired digital picture using the user device;
sending the digital picture and frame type selection from the user device to an order processor, such that the order processor can control printing of the sent digital printer and framing of the printed printer according to the sent selected frame type and delivery details can be applied to the framed picture for delivery to a delivery address according to the delivery details.

16. A computer program product in a tangible computer readable form comprising instructions configured to control a processor of a user device to:
acquire a digital picture using the user device;
select a frame type for framing the acquired digital picture using the user device;
send the digital picture and frame type selection from the user device to an order processor, such that the order processor can control printing of the sent digital printer and framing of the printed printer according to the sent selected frame type and delivery details can be applied to the framed picture for delivery to a delivery address according to the delivery details.

17. A system for receiving an order, manufacturing and delivery of a framed picture comprising:
a receiver for receiving from a user device delivery details, selection of a stored digital picture or a download of a digital picture and a frame type selection;
a picture printer and framer for manufacturing the framed picture from the selected frame type and the sent digital picture;
a delivery details applicator for applying the delivery details received by the order processor to the manufactured framed picture for identifying the delivery address such that the manufactured framed picture is able to be delivered to the delivery address according to the delivery details.

18. A method of manufacturing and delivery of a framed picture comprising:
receiving from a user device delivery details, selection of a stored digital picture or a download of a digital picture and a frame type selection;
manufacturing the framed picture from the selected frame type and the selected or sent digital picture;
applying the delivery details to the manufactured framed picture for identifying the delivery address;
delivering the manufactured framed picture to the delivery address according to the delivery details.
